(19) United States
(12) Patent Application Publication
(10) Pub. No.: US 2023/0276723 A1
(43) Pub. Date: Sep. 7, 2023

(54) METHOD AND APPARATUS FOR WEED CONTROL USING A HIGH INTENSITY LIGHT SOURCE

(71) Applicant: Troy R Benjegerdes, Minneapolis, MN (US)

(72) Inventor: Troy R Benjegerdes, Minneapolis, MN (US)

(21) Appl. No.: 18/317,083

(22) Filed: May 14, 2023

Related U.S. Application Data
(63) Continuation-in-part of application No. 16/204,820, filed on Nov. 29, 2018, now Pat. No. 11,690,369.

(51) Int. Cl. A01B 39/18; G05B 13/02

(52) U.S. Cl. CPC A01B 39/18; G05B 13/021

(57) ABSTRACT

An apparatus and method for control of undesired vegetation. A renewable power source, tractor, and high intensity light source are provided and moved over an area of land. Exposure of unwanted vegetation to the high intensity light kills the unwanted vegetation.

### CROSS-REFERENCE TO RELATED APPLICATIONS

This application is a continuation in part of U.S. application Ser. No. 16/204,820, filed on Nov. 29, 2018, which claims priority to U.S. Provisional Patent Application No. 62/591,904, filed on Nov. 29, 2017, and the entirety of both applications is hereby incorporated herein by reference.

### FIELD OF THE INVENTION

This invention pertains generally to agronomic weed control. In particular, this invention provides for methods and apparatus for agronomic weed control by exposing undesired vegetation to high intensity lights sufficient to control the growth of or kill the undesired vegetation.

### BACKGROUND

In order to produce high-yielding food crops, the desired crops must be relatively free from competing undesired plants (weeds). The current state of the art utilizes toxic chemicals and genetically modified (GMO) crops resistant to said chemicals, which have damaging environmental impacts, and increase costs for farm operators. Prior to GMO crops, multiple toxic chemicals and soil disturbing, erosion promoting, and fuel intensive tillage has been used for weed control.

As an alternative to the use of chemicals or tillage, a flame weeder kills weeds by applying flame to undesired vegetation. While the flame weeder avoids the negative effects of agricultural chemicals and tillage, it is fuel intensive.

Thus, a weed control method that avoids the negative impact of chemicals and intensive tillage that also minimizes or eliminates fuel use is desired.

### BRIEF SUMMARY

In accordance with one embodiment of the invention, an apparatus and method for weed control are provided. The apparatus comprises a power subassembly, a tractor, and a light subassembly. The power subassembly comprises a solar panel and a power management module, and is configured to provide renewable energy to other components of the apparatus. The tractor is configured to convey the apparatus over an area of land. The light subassembly comprises a high intensity light source. As the apparatus traverses over an area of land, vegetation directly beneath the light subassembly is exposed to high intensity light configured to control the growth of unwanted vegetation.

An object of this invention is to provide a method to control undesired vegetation growth in agricultural production applications. Growth management and weed killing may be accomplished by localized heating and tissue damage of target vegetation or by another mode of action induced by exposing plant tissue to high intensity light source.

It is a further object of this invention to provide such a method for providing a control and operating mechanism to control light energy dosage based on presence or absence of vegetation matter.

It is a further object of this invention to provide such an improved control system for operating the energy-intensive weed control process to act as a power grid stabilization and regulation function, by adjusting input power based on a signal from a power grid regulator (‘balancing authority’) or via a real-time market based mechanism. (Smart grid integration).

The proposed apparatus and method can be implemented using less total embodied energy than those of toxic chemicals, or extensive tillage, and can be powered entirely by on-farm renewable solar and wind energy electrical generation sources.

### BRIEF DESCRIPTION OF THE DRAWINGS

Having thus described the invention in general terms, reference will now be made to the accompanying drawings, which are not necessarily drawn to scale, and wherein:

FIG. 1 illustrates an external side view of an apparatus for controlling unwanted vegetation in accordance with an embodiment of the invention.

FIG. 2 illustrates a power subassembly of an apparatus for controlling unwanted vegetation in accordance with an embodiment of the invention.

FIG. 3 illustrates a tractor of an apparatus for controlling unwanted vegetation in accordance with an embodiment of the invention.

FIG. 4 illustrates a light subassembly of an apparatus for controlling unwanted vegetation in accordance with an embodiment of the invention.

FIG. 5 illustrates a method for controlling unwanted vegetation in accordance with an embodiment of the invention.

FIG. 6 illustrates an alternative embodiment of a tractor of an apparatus for controlling unwanted vegetation in accordance with an embodiment of the invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus are not shown in one or more of the figures for clarity and to facilitate explanation of embodiments of the present invention.

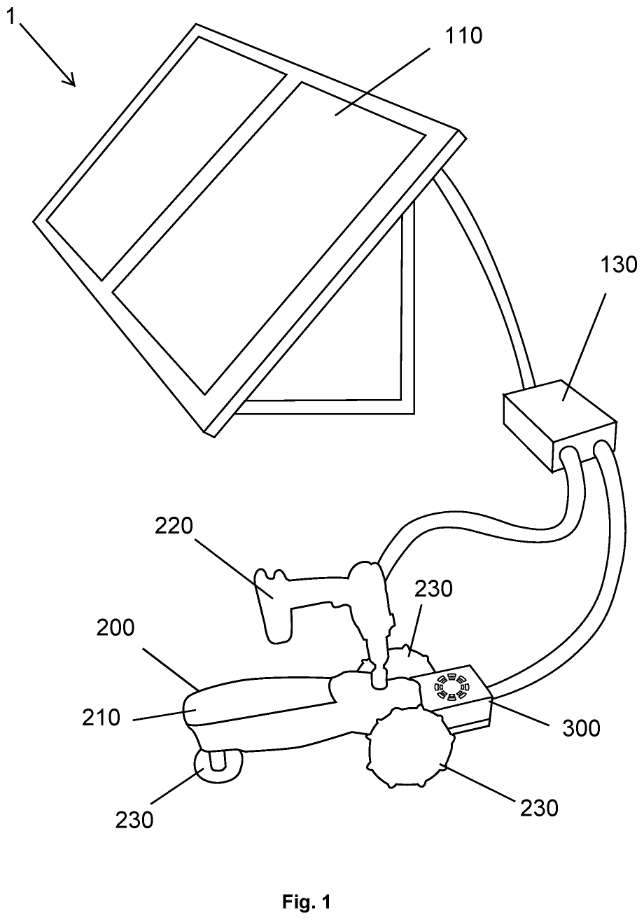

In accordance with one embodiment, FIG. 1 illustrates an apparatus 1 for controlling weeds using a high intensity light source. Apparatus 1 comprises a power subassembly 100, a tractor 200, and a light subassembly 300. Apparatus 1 may further comprise one or more embedded processor and user-interface elements configured to communicate with and control the components of apparatus 1 via wired or wireless connection. User interface interaction with the processor elements may be via direct tactile switches, touch-screen tablets and/or smartphone apps, visual gesture recognition, or audio voice recognition.

Power Subassembly 100

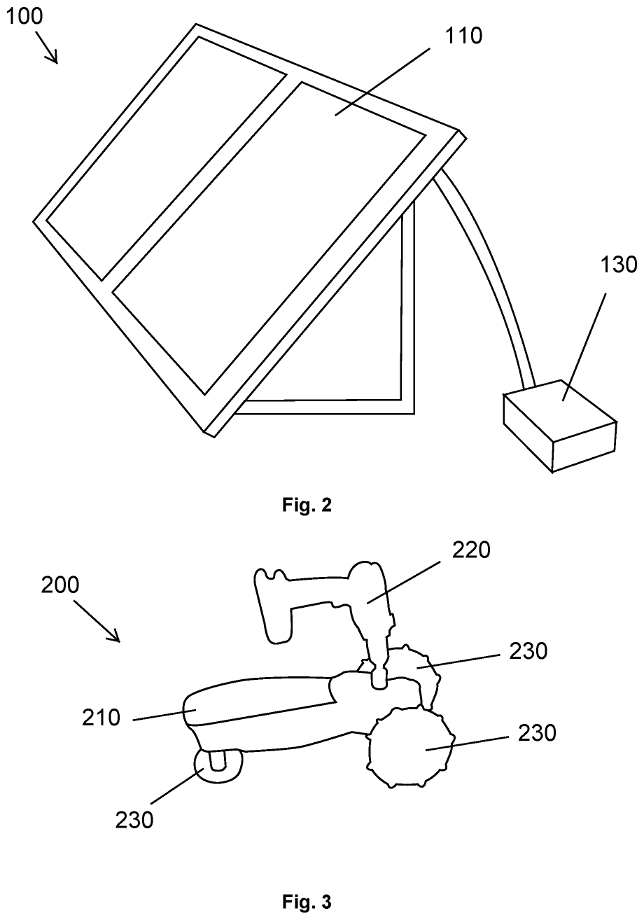

As shown in FIG. 2, in one embodiment power subassembly 100 comprises a solar panel 110 and a power management module 130. The solar panel 110 collects solar energy, converts it to electricity, and stores it internally in a battery for use by the tractor 200, the light subassembly 300, and any other components of apparatus 1 that require electrical power. The battery of solar panel 110 is electrically connected to the power management module 130. The power management module 130 provides power conditioning for the electrical energy stored in the battery of the solar panel 110, and is electrically connected to the tractor 200 and the light subassembly 300 via low-voltage DC power. The solar panel 110 and power management module 130 may be stationary or mounted on the tractor 200. If solar panel 110 and power management module 130 are stationary, mobile components are connected via movable wire tethers.

Tractor 200

As shown in FIG. 3, in one embodiment tractor 200 comprises a body 210, driver 220, and wheels 230. Tractor 200 is capable of movement over an area of land to cause the light subassembly 300 to travel over the area of land. The body 210 comprises a structure made of metal, plastic, wood, or other material to which the light subassembly 300 is mounted. Wheels 230 are rotatably attached to the body 210, allowing tractor 200 to roll over an area of land. In one embodiment, a lawn sprinkler tractor may be used as the body 210 and wheels 230 of tractor 200.

The driver 220 comprises a power supply that is electrically connected to the power management module 130 and a shaft that is mechanically coupled to the wheels or track system 230. Power supplied from the power management module 130 causes the shaft of the driver 220 to rotate. Rotation of the shaft causes rotation of the wheels or track system 230, which in turn causes the tractor 200 to move. In one embodiment, a drill may be used as the driver 220.

As shown in FIG. 6, an alternative embodiment of a tractor 200′, body 210′ and wheels 230′ are constructed from bicycle parts. In this alternative embodiment, a human operator takes the place of driver 220 for providing power to the tractor 200′. The power subassembly 100 and light subassembly 300 are mounted to a structure that is coupled to bicycle frame. The power subassembly in this alternative embodiment provides power to the light subassembly 300.

As shown in US20210219481A1, an alternative embodiment of the tractor 200′, body 210′ and wheels 230′ as part of the track assembly which cause the tractor to move when driven by electric motors connected to the power management module 130.

Light Subassembly 300

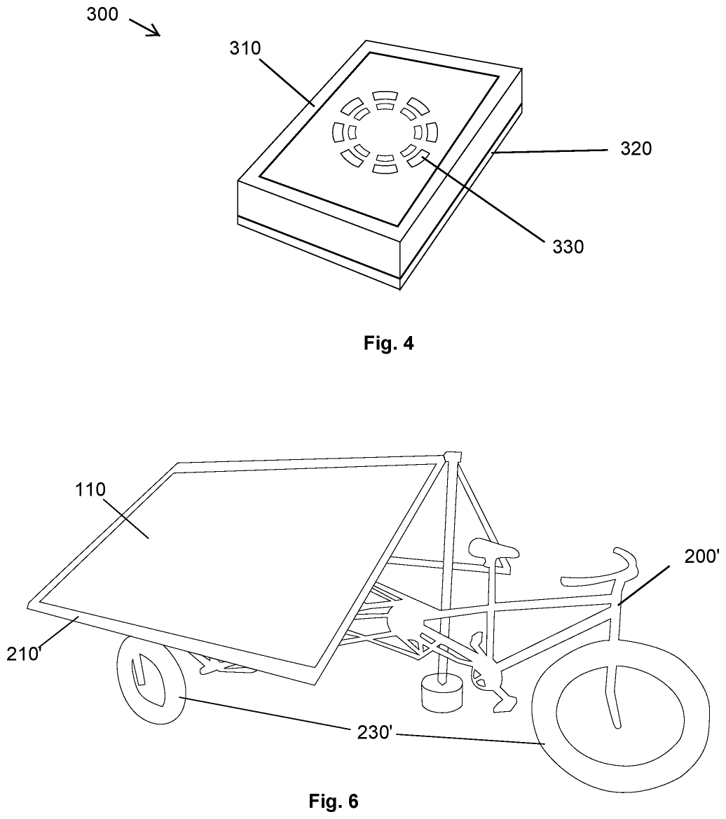

As shown in FIG. 4, the light subassembly 300 comprises a mobile platform 310 mounted to the body 210 of tractor 200, a high intensity light 320, and a power supply 330.

The mobile platform 310 comprises surfaces to which the components of the light subassembly 300 may be mounted, including the power supply 330 and high intensity light 320. Mobile platform 310 may be constructed of metal, wood, plastic, or other suitable material.

The high intensity light 320 is mounted to mobile platform 310 such that light is directed downward onto an area of land as the tractor 200 travels over the area. When vegetation is exposed to the light of high intensity light 320, surface heating of the vegetation's tissues occurs, causing the vegetation to inhibit its growth or die depending on the power level of the high intensity light 320. High intensity light 320 may comprise one or more visible light sources (i.e. light emitting diodes (LEDs), incandescent bulbs, or lasers), near infrared light sources, or any combination. Experimental results and market conditions indicate commodity high-intensity blue LEDs in the 650 nm range may provide the best cost/performance profile. Mixing unfocused LED light with highly focused laser light as shown in US-20220299635-A1 and US-20230137419-A1 may provide additional economic benefits when combined with cover crops and no-till farming practices.

The power supply 330 is mounted to the mobile platform 310 and electrically connected to the power management module 130 and the high intensity light 320. Power supply 330 is capable of supplying power to the high intensity light 320.

Method

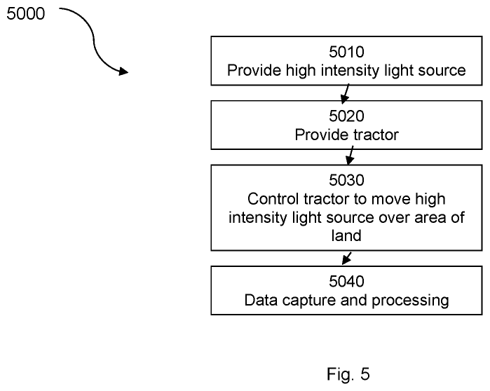

As shown in FIG. 5, a method 5000 for controlling unwanted vegetation using high intensity light begins at step 5010 with providing a high intensity light source, such as the light subassembly 300 previously described, powered by renewable energy.

The method 5000 continues at step 5020 with providing a tractor configured to move the high intensity light source. The tractor may be the tractor 200 or 200′ as previously described.

The method 5000 continues at step 5030 with controlling the tractor to move the high intensity light source over an area of land. Experimental results show browning of grass when the tractor 200 was operated at slow speed. When operated at high speed, the effect is barely visible, indicating higher power levels are required. Observation of the grass also indicated that only vegetation very close to the plastic window protecting the LED emitter was killed, and higher power levels may be required. The total irradiation dosage exceeds 1 kilowatt per square meter and a threshold dosage (joule per square meter).

The method 5000 may further comprise step 5040 in which data is captured by a processor and provided to an operator in real time such that the operator can modify the path of travel or other behaviors of the apparatus 1 using the processor. The operator receiving the captured data may be present at the location of the apparatus 1, or operator may be at a remote location. Step 5040 may comprise capturing images of vegetation and providing the images to an operator allowing the operator to identify undesired vegetation in real time and direct the high intensity light source to areas with unwanted vegetation. The captured images may be displayed on a monitor, tablet, smart phone, or similar device, or the captured images may be displayed to the operator using an augmented reality visual interface. Further embodiments may contain machine-learning software and hardware to learn and then autonomously apply training from an operator, either in real-time, or after the fact.

Step 5040 may comprise dynamically varying energy utilization and associated heat production based on a control input. In general, an operator attempts to operate a machine such as apparatus 1 such that energy usage and heat production are minimized. However, various circumstances can cause an operator to use energy differently or create heat if it makes more economic sense to do so. For example, if an operator has access to one or more wind power generators, and electricity for operating apparatus 1 is effectively free, the operator may increase the speed of the apparatus 1, increase the power level of the apparatus 1, or otherwise operate apparatus 1 in a manner that is not energy efficient or produces excessive heat. As another example, if electric utilities are experiencing peak demand, it may make more economic sense to sell renewable energy generated on the farm to an electric utility rather than use the energy to control unwanted vegetation on that particular day, and the operator may slow or even stop use of apparatus 1. To assist with making such decisions, energy cost information may be accessed and made available to the operator. The speed, power level, and other aspects of the operation of apparatus 1 may be modified manually by the operator, or aspects of the operation of apparatus 1 may be controlled automatically if defined criteria are met. Thus, step 5040 may comprise managing costs when linked with real-time power markets.

Controlling unwanted vegetation may sometimes mean killing or even completely removing all of the unwanted vegetation, but doing so comes with a number of associated costs, including additional energy usage, additional heat generation, increased capital expenditure, utilization of equipment, machinery wear and tear, potential destruction of biomass that would otherwise prevent soil erosion if left to grow in a controlled manner, and other effects. Killing or destroying vegetation may not be desirable when the entirety of the costs and effects are understood. Therefore, controlling unwanted vegetation may alternatively entail killing some of the unwanted vegetation or just damaging it enough to allow it to keep growing in a controlled manner. At step 5040, the user may be presented with the total costs of various vegetative control scenarios in terms of energy usage, additional heat generation, increased capital expenditure, utilization of equipment, machinery wear and tear, potential destruction of biomass that would otherwise prevent soil erosion if left to grow in a controlled manner, and other effects. The user may then determine what level of control of the vegetation should be used based on the total cost and modify the behavior of the tractor accordingly to achieve the desired level of control.

To determine the total costs of various vegetative control scenarios, a user may first input into software running on a processor an area of land on which to implement the method 5000. Inputting the area of land may involve driving the perimeter of the area while recording GPS coordinates, entering the latitude and longitude of the corners of a shape defining the area, simply entering an area in acres that will be treated, or another method of providing information about the size or location of the area to be treated to the processor. If any parameters are to be held constant, the constant parameters may also be input by the user into software running on the processor. For example, the power level, wavelength of light, speed, completion time, or another parameter may be set. The user may also input the specific vegetative control scenarios to be examined. For example, the user may wish to see the total costs of not controlling unwanted vegetation on the area of land, 50% inhibition of the unwanted vegetation, and killing the unwanted vegetation; however any number of scenarios and type of scenarios ranging from 0% control (no use of the apparatus 1) to 100% control (killing) of unwanted vegetation may be calculated and presented to the user. The total costs of the various scenarios are then calculated and presented to the user. In one embodiment, the total energy usage, total time required, wear and tear on the apparatus 1, measure of benefit to the desired plants in the area, and other parameters may be calculated and displayed to the user. Using the displayed information, the user may then choose which scenario to pursue, and the settings of apparatus are modified to achieve the desired scenario. For example, the speed, power level, and wavelengths of apparatus 1 may be altered to match the desired scenario. A further example may involve display of real-time and/or futures prices for electric power, the commodity crop being produced, and other variable factors impacting the total cost of operation. These displays may be made to both the direct farm operator, or to other interested stakeholders, such as speculators and buyers of farm products.

Controlling unwanted vegetation could also mean controlling the growth of cover crops. The cover crops may be exposed to different wavelengths of light to affect the growth of the crops to either enhance or inhibit their growth. An example of this may include, but is not exclusive to, using red light (700 to 750 nm wavelength) for promoting growth of target cover crops while illuminating undesired vegetation with 450 nm blue light to control and limit growth rate.

Step 5040 may comprise controlling heat production for a heat recovery power production.

### Alternative Embodiments

In addition or as an alternative to the light subassembly 300, apparatus 1 may comprise attachments such as mechanical cutters for cutting or removing vegetation, or a high voltage, high power mechanism configured to apply electric current from target weeds to ground sufficient to disrupt further weed growth. Attachments can be powered and moved through the field under autonomous control by an on-board computing element. Further extensions may connect the tractor 200 via a tether or center-pivot type rotating platform to a fixed power grid which can be either isolated or connected to external power grids. If connected to external power grids with real-time market prices, software operating both on the apparatus 1 and in fixed grid interfaces will optimize operation of apparatus 1, weed control activities, and power production to maximize net farm revenue from electricity, crop market prices, and carbon credit/tax offsets.

Further enhancements may include replacing power subassembly 100 with a combustion engine specifically modified to produce oxides of nitrogen, and redirect the exhaust gas into the soil as a nitrogen fertilizer.

Software trading systems and aggregation of many distributed systems can be performed to increase the market value, liquidity, and effectiveness of food production, and increase value to consumers and farmers with full chain of custody recording of all inputs, the specific time of the input, and associated carbon source or sink intensity of the crop input, and expose this data to consumers via a public blockchain ledger.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for controlling undesired vegetation comprising:
providing a high intensity light source,
providing a tractor configured to move the high intensity light source, and
controlling the tractor to move the high intensity light source over an area of land; and
providing remote human in-the-loop feedback to modify the behavior of the tractor in real time.

2. The method of claim 1 wherein the high intensity light source comprises a high intensity visible and near UV light.

3. The method of claim 1 wherein the high intensity light source comprises light-emitting-diodes.

4. The method of claim 1 wherein modifying the behavior of the tractor comprises dynamically varying energy utilization and associated heat production based on a control input.

5. The method of claim 1 wherein modifying the behavior of the tractor comprises managing costs when linked with real-time power markets.

6. The method of claim 1 wherein modifying the behavior of the tractor comprises controlling heat production for a heat recovery power production.

7. The method of claim 1 wherein providing remote human in-the-loop feedback to modify the behavior of the tractor in real time comprises providing audio, visual, or tactile feedback which may include displaying images of vegetation or providing real-time market price information to a remote or on-site user.

8. The method of claim 7 wherein the audio, visual, or tactile feedback is provided using an augmented reality visual and/or auditory user interface.

9. The method of claim 1 further comprising calculating the costs of one or more vegetative control scenarios and presenting the costs of the one or more vegetative control scenarios to a user.

10. The method of claim 9 wherein providing human in-the-loop feedback to modify the behavior of the tractor in real time comprises receiving input from the user to implement a chosen vegetative control scenario.

11. The method of claim 9 wherein providing human in-the-loop feedback to modify behavior of the tractor comprises presenting to the user real-time, direct, and futures market prices.

12. The method of claim 1 where buyers of the farm products can be exposed to one or more production cost trade-offs through an interactive user interface.
